(19) United States
(12) Patent Application Publication
(10) Pub. No.: US 2016/0021859 A1
(43) Pub. Date: Jan. 28, 2016

(54) SYSTEM, METHOD AND APPARATUS FOR A HOLLOW SHANK FISHING HOOK

(71) Applicants: Dwane K. Stull, Newton Falls, OH (US); Julius Szabo, Crescent City, FL (US)

(72) Inventors: Dwane K. Stull, Newton Falls, OH (US); Julius Szabo, Crescent City, FL (US)

(21) Appl. No.: 14/339,771

(22) Filed: Jul. 24, 2014

(51) Int. Cl. A01K 91/04; A01K 83/00

(52) U.S. Cl. CPC A01K 91/04; A01K 83/00

(57) ABSTRACT

A hollow shank fishing hook that will avoid the use of knots entirely, simplifying the profile of the fishing hook, making it easier for the end user to attach the lead line to a hook, simplifying manufacturing, reducing the propensity of hook to catch debris in water and creating less auditory and visual distraction of the fish. Combined line entry and egress provide for a line retention within the hook by adhesive coating thereon.

### BACKGROUND OF THE INVENTION

1. Technical Field

This invention relates to the field of fishing and more particularly to a system for attaching a leader line to a fishing hook without tying a knot or binding/lashing the leader line to the hook.

Fishing is an activity that dates back to as far as 40,000 years ago. Hooks for fishing have been found that date back to the Stone Age. The key portion of nearly every fishing system is the hook itself. To be part of the fishing system, the hook must somehow be connected to the user, which is usually done by the use of a fishing line. The means of connecting the generally rigid fishing hook to the flexible fishing line has been a problem fishermen have attempted to address for centuries. The two main methods of attachment are tying a knot that passes through the eye at the top of the hook, or to use a snell knot (i.e., binding/lashing knot), which may or may not pass through an eye at the top of the hook, instead gaining most of its strength from being bound to the hook shaft.

2. Description of Prior Art

An attempt to solve the problem of attaching a fishing line to a hook is shown in U.S. Pat. No. 1,156,152 to Krenrick, that shows the wrapping that would be provided by the snell knot replaced with a band that crimps around the fishing line. But the line still needs a knot at the end of the line to prevent it from passing through the band, and the hollow portion is not through the center of the fishing hook. Additionally, given that the band is attached to the side of the shank, it creates yet another location for seaweed and other detritus to become caught, fouling the hook, line, and bait.

US Pat. App. 2007/0169399 describes a tube attached to the shank portion of a fishing hook, where the fishing line then passes through the tube. But this device still requires a knot at the end of the line to prevent the hook from slipping off the line, and the tube portion is not at the center of the hook. As discussed above, this attachment mechanism also creates yet another location for debris to become caught.

US Pat. App. 2009/0313878 describes a method for securing fishing line to a hook, where the fishing line is passed around a helical coil, wraps over itself and forms a type of knot. This method still requires the user to tie a knot, makes the hook more complicated rather than less complicated, and creates more turbulence and a greater propensity for catching debris as a result of the complicated shank.

What is needed is a system that will avoid the use of knots entirely, simplifying the profile of the fishing hook, making it easier for the end user to attach the leader line to the hook, simplifying manufacturing, reducing the propensity of the hook to catch debris in the water, and creating less auditory and visual distraction of the fish.

### SUMMARY OF THE INVENTION

In one embodiment, a apparatus is disclosed including a hollow shank fishing hook, the hollow shank fishing hook comprising an elongated shank, the shank having a cross-sectional shape with a first end and a second end; and a reservoir starting in the first end of the elongated shank, the reservoir comprising a hollow portion of the elongated shank; and the second end of the elongated shank continuing into at least one elongated arm, each of the at least one elongated arms terminating in a point.

In another embodiment, an apparatus is disclosed including a left section and a right section, the left section and the right section combining to form an elongated shank, the shank having a cross-sectional shape with a first end and a second end; and a reservoir, the reservoir starting in the first end of the elongated shank, the reservoir comprising a hollow portion of the shank; and the second end of the elongated shank continuing into at least one elongated arm, each of the at least one elongated arms terminating in a point.

In another embodiment, a fishing hook configuration is disclosed having a secondary opening in the curved portion of the hollow shank defining an exit and return portal of a fishing line inserted into the open shank end for adhesion retainment therewithin.

### DESCRIPTION OF THE DRAWINGS

The invention can be best understood by those having ordinary skill in the art by reference to the following detailed description when considered in conjunction with the accompanying drawings in which:

FIG. 1 illustrates an isometric view of a first embodiment of the hollow fish hook design.

FIGS. 2A and 2B illustrate a second embodiment, showing both an enlarged hollow chamber and a two-part mixable adhesive.

FIG. 3 illustrates a third embodiment, showing both an enlarged hollow chamber and an offset believed to increase the strength of the adhesive bond.

FIGS. 4A and 4B illustrate a two part hook with an adhesive means for attaching the hook to the leader line.

FIGS. 5A and 5B illustrate a two part hook with a mechanical means for attaching the hook to the leader line.

FIG. 6 is a cross-sectional view of the third embodiment of the hollow fishing hook design showing the hollow hook body with an exit and return opening therewithin.

FIG. 7 is a cross-sectional view showing a line inserted through the hook body during use with an extended portion being covered with adhesive.

FIG. 8 is a cross-sectional view of the hollow hook body shown in FIG. 7 with the adhesive coated line retracted back within a portion of the hollow hook shank and secured therewithin.

FIG. 9 is a second alternate form of the hollow hook body shown in FIGS. 6, 7 and 8 where only a portion of the hook is hollow extending only to the outlet and retrieval opening therewithin.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

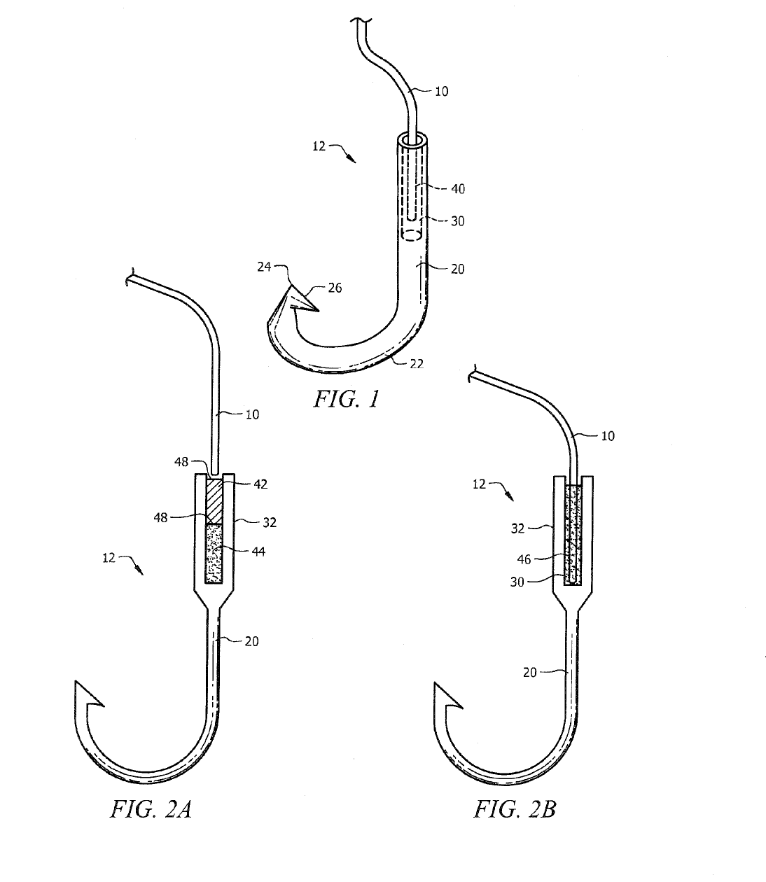

Referring to FIG. 1, an embodiment of the hollow shank fishing hook 12 will be described. Like most fishing hooks, the hollow shank fishing hook 12 is comprised of a shank 20, a bend 22, a point 24, and a barb 26. The cross-sectional shape of the hook in the examples shown is generally circular or elliptical, but any shape is anticipated, including square, rectangular, triangular, or any other regular or irregular polygonal shape. This cross sectional shape is elongated to form the length of the shank 20. The bend 22 is an extension of the elongated shank and preferably follows a curved, arcing path, but other shapes are anticipated such as shapes with sharp corners, a series of segments, either straight or curved sections, that in the aggregate create a curve, or even a ninety-degree bends that form a hook bottom. The bend and barb 26 portion of the hollow shank fishing hook 12 is anticipated to be any known or future bend and barb configuration as known in the industry.

The point 24 and barb 26 shown in the figures are typical. Any shape point 24 and barb 26 commonly known in the art are anticipated. While the figures show a hollow shank fishing hook with only one bend 22, associated point 24, and barb 26, any number of bends/points/barbs 22/24/26 is anticipated, including double or treble hooks (i.e., hooks with two or three bends/points/barbs 22/24/26).

Missing from the hollow shank fishing hook 12 is an eye; a necessity for most fishing hooks of the prior art. Instead of an eye, the hollow shank fishing hook 12 has a hollow shank reservoir 30. The fishing line 10 is fed into the reservoir 30 and affixed to the hollow shank fishing hook 12 by a variety of means, in this case, an adhesive 40 fills the reservoir, permanently attaching the hollow shank fishing hook 12 to the fishing line 10. The reservoir as shown in the examples is generally cylindrical and axially aligned with the shank, but there is no requirement of a specific shape or position and any shape and/or position is anticipated. The cross-sectional shape of the reservoir as shown in the examples is generally circular, but any shape is anticipated, including elliptical, square, rectangular, triangular, or any other regular or irregular shape. The reservoir forms a hollow portion within the shank of the hook.

The fishing line 10 is typically made of an artificial material, such as nylon, polyvinylidene fluoride (PVDF), polyethylene, Dacron, etc. But the fishing line 10 is not limited to such materials and is anticipated to be made of any material known in the industry, including natural materials such as cotton, synthetic materials as described, or metals such as aluminum or stainless steel as often used for leader lines. In some embodiments fishing line 10 composed of a single strand (i.e., monofilament) but in other embodiments is constructed of any number of strands. The hollow shank fishing hook 12 is ideal for multifilament line due to the difficulty such line presents when attempting to tie knots. While not required, in the preferred embodiments the fishing line 10 is made of fluorocarbon material composed of fluoropolymer PVDF because it has a refractive index that is very similar to water, making the fishing line 10 nearly invisible to fish. In some embodiments, the fishing line 10 is the main line that is continuous all the way back to the user. In some embodiments, the fishing line 10 is a shorter line known as a “leader line” that is subsequently attached to the main fishing line 10. In embodiments in which the fishing line 10 is a “leader line”, any length of leader line is anticipated, though the leader line is often short (e.g. 12 inches) due to ease of packaging and manufacturing. In embodiments in which the fishing line 10 is the main line that is continuous all the way back to the user, the user determines what type of line is inserted, depending on the desired use.

In the example of FIG. 1, either the fishing line 10 is coated with an adhesive before inserting the fishing line 10 into the reservoir 30 or the reservoir 30 is prefilled with an adhesive (see FIGS. 2A and 2B) and either the fishing line 10 is inserted into the reservoir and bonds to the adhesive or the fishing line 10 is pre-treated to initiate bonding (e.g. the end of the fishing line 10 is moistened before insertion into the reservoir 30). In other embodiments, the reservoir 30 is prefilled with adhesive, and crimped/crushed to activate the adhesive.

FIGS. 2A and 2B show another embodiment of the hollow shank fishing hook 12 with a two-part adhesive and an enlarged shank 32 to contain the reservoir. Depending on the relative sizes of the shank 20 and the fishing line 10, in some embodiments, the diameter of the shank 20 is exaggerated or enlarged to create an enlarged shank 32 to allow room for the fishing line 10 and reservoir 30.

FIG. 2A shows a hollow shank fishing hook 12 with a two part adhesive (e.g., epoxy), adhesive part A 42 and adhesive part B 44. There is no requirement that the adhesive only be two part, and in some embodiments is comprised of three or more parts. The adhesives are separated from each other, and the atmosphere, by membranes 48. The membrane 48 is comprised of any material that prevents the relevant liquid or gas from penetrating and activating the adhesive (e.g., prevents the entry of water if the adhesive is water activated, or the escape of the solvent if the solvent evaporates to activate the adhesive, etc.). The fishing line 10 is pushed through the membranes and into the adhesives 42 and 44, mixing the adhesives to initiate bonding. The mixing of the adhesives 42 and 44 starts a chemical reaction, resulting in a cured adhesive 46 that bonds the fishing line 10 to the reservoir 30. In other embodiments, the adhesive is injected using a hypodermic needle that includes a mixing tip. The adhesive, if comprised of multiple parts, is held within multiple containers within the needle, and mixed in the tip during injection into the reservoir 30. The tip may then be broken off, a new reservoir attached, and a new tip used to fill a different reservoir. In some embodiments the adhesive is injected before the line 10 is inserted, and in other embodiments the adhesive is injected after the line 10 is inserted.

In other embodiments, rather than a two part adhesive, a single part adhesive may be used. It is envisioned that the single part adhesive is separated from the atmosphere by an optional membrane 48, as necessary, to prevent premature activation. Single part adhesives cure by, for example, the evaporation of a solvent (e.g., water, alcohol, etc.), a chemical reaction between the adhesive and another chemical (e.g., water vapor, liquid water applied to the fishing line 10 prior to insertion, saliva, oxygen, etc.), or in reaction to an external energy source (e.g., ultraviolet light, heat, etc.). In still other embodiments, the portion of the shank 20 or enlarged shank 32 that contains the reservoir 30 is made of a flexible or malleable material lined with a pressure sensitive adhesive. The fishing line 10 is inserted into the reservoir 30, and the reservoir is compressed to press the adhesive 46 against the fishing line 10.

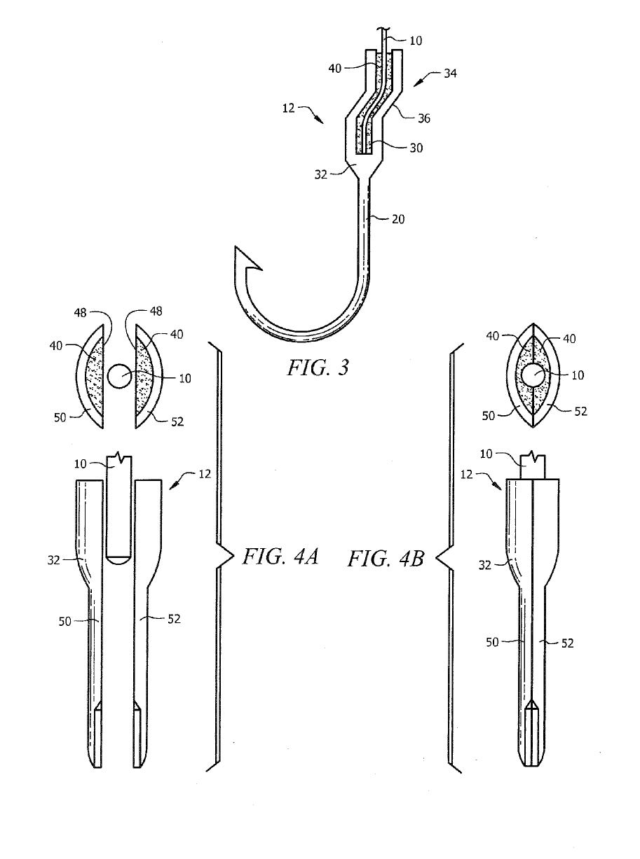

Referring to FIG. 3, the hollow shank fishing hook 12 with crooked shank 34 will be discussed. In this example, a non-linear shank provides a greater sealing strength than a linear shank by dividing the resulting stress between the horizontal and vertical directions. “Non-linear” indicates a portion that is not parallel to the main shank 20 of the hollow shaft fishing hook 12. For an example, for a bond where the adhesive 40 is lining the walls of a linear reservoir, under force, the point of failure (assuming the hook and fishing line do not fail first) is predicted to be the bond between the fishing line 10 and the crooked shank 36. As the fishing line 10 is pulled in a vertically upward direction (parallel to the reservoir 30) and the walls of the reservoir 30 pulled in the opposite direction (e.g. by a fish), it is predicted that the adhesive will shear along one of those surfaces (or within the adhesive itself, if the bond is stronger than the adhesive). As a second example, using the same directional forces as above, it is predicted that in some instances the point of failure (assuming the hook and fishing line do not fail first) is to be the bond between the fishing line 10 and the linear shank 20. The shape of the crooked shank 34 will prevent the fishing line 10 and adhesive 40 from sliding out of the crooked shank 34, preventing the hollow shank fishing hook 12 from disconnecting from the fishing line 10. This bond is strong enough for many fishing applications but there are some applications that require a stronger bond such as sport fishing for game fish such as Marlin and Sailfish.

In embodiments as shown in FIG. 3, the crooked shank 34 along the non-linear section or sections 36 resists pure shear force because the fishing line 10 and the walls of the reservoir 30 are not parallel to the direction of the force. Instead, the load on the adhesive at that point is a mix of shear, tensile, and compressive stresses. Depending on the type of adhesive 40, reservoir 30 material and surface structure, fishing line 10 material and surface structure, the crooked shank 34 and reservoir 30 withstands higher forces before failure than a straight shank 34. This embodiment is not limited to a specific number of bends in the reservoir 30, or any specific shape of bend (i.e., in some embodiments the bends are at sharp angles, rounded, bent along a 2D plane, or within 3D space such as a helical/spiral bend). FIG. 3 is shown with an enlarged shank 32, but this is not a requirement. The relative sizes of the hollow shank fishing hook 12 and the fishing line 10 will dictate whether it is necessary that the shank be enlarged.

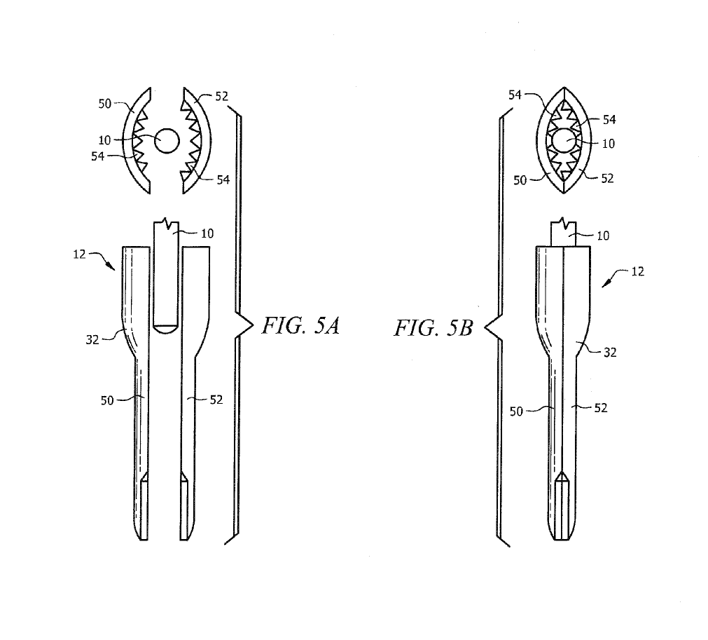

Referring to FIGS. 4A, 4B, 5A and 5B a two part embodiment of the hollow shank fishing hook 12 is discussed. In this embodiment, rather than the fishing line 10 being inserted into the hollow shank of the fishing hook 12, the two sections 50/52 (e.g. halves, but not limited to halves) of the hollow shank fishing hook 12 are joined with the fishing line 10 trapped between the two sections 50/52. In the examples shown, the cross-sectional shape of the hook is generally circular, but any shape is anticipated, including elliptical, square, rectangular, triangular, or any other polygonal shape. This cross sectional shape is elongated to form the length of the shank. The bend generally follows a curved, arcing path, but is not limited to any particular shape. Shapes such as sharp corners, a series of segments, either straight or curved sections, that in the aggregate create a curve, or even a ninety-degree bends that form a hook bottom are some examples. In some embodiments the surface between the two sections 50/52 of the hollow shank fishing hook 12 is flat, but in other embodiments each side is curved, ridged, any other shape that allows the two sections 50/52 to mate. In this embodiment the adhesive 40 is split between the left section 50 of the hook and the right section 52 of the hook, as shown in FIG. 4A. When the two sections 50/52 are joined, as shown in FIG. 4B, the adhesive is activated and forms around the fishing line 10. In some embodiments, the adhesive is separated from the atmosphere by an optional membrane 48, to prevent premature activation. The adhesive cures by any way known in the industry, including, but not limited to, the evaporation of a solvent (e.g., water, alcohol, etc.), a chemical reaction between the adhesive and another chemical (e.g., water vapor, liquid water applied to the fishing line 10 prior to insertion, saliva, oxygen, etc.), or in reaction to an external energy source (e.g., ultraviolet light, heat, etc.). In still other embodiments, the adhesive is a pressure sensitive adhesive. When the two sections 50/52 are combined, as shown in FIG. 4B the adhesive 40 is compressed against the fishing line 10 and forms a bond. In other embodiments, the adhesive is a two or more part adhesive that mixes during the assembly of the two sections 50/52 FIGS. 4A and 4B are shown with an enlarged shank 32, but this is not a requirement. The relative sizes of the fishing hook and the fishing line 10 will dictate whether it is necessary that the shank be enlarged.

It is anticipated that, in some embodiments, additional elements are provided to properly align the two sections 50/52 during assembly, such as a teeth or pegs on one section 50 and associated cavities on the other section 52, ridged surfaces, peaks on one section and valleys on the other, nubs on one section 50 with holes on the other section 52, etc. In some embodiments the reservoir does not exist prior to the joining of the two sections 50/52. In such embodiments, when the two sections 50/52 are combined around the fishing line 10 the reservoir is created within two sections 50/52 to make room for the fishing line 10. Any method as known in the art is anticipated to join the two sections, including adhesives, fusion bonding, hot gas welding, vibration welding, solvent bonding, ultrasonic welding, induction welding, arc welding, gas welding, etc.

FIGS. 5A and 5B show a slightly different embodiment where the adhesive 40 has been replaced by a mechanical means 54, illustrated as teeth. In this embodiment, the fishing line 10 is placed between the fishing hook sections 50/52, the fishing hook sections 50/52 are joined, and the fishing hook two sections 50/52 are bonded together. The fishing line 10 is held in place by teeth, barbs, or pressure from the walls of the fishing hook sections 50/52 that protrude from each section and press against the surface of the fishing line 10. The fishing hook sections 50/52 are compressed against or around the fishing line 10 and bonded together as known in the art, for example by fusion bonding, hot gas welding, vibration welding, solvent bonding, ultrasonic welding, induction welding, arc welding, gas welding. Note that any number of sections 50/52 is anticipated.

In some embodiments, the hollow shank fishing hook 12 is molded around the fishing line 10. In this embodiment, the fishing line 10 is inserted into a mold, and the hollow shank fishing hook 12 is molded around the fishing line 10. In other embodiments, the fishing line 10 is inserted into a still malleable fishing hook 12. In still other embodiments the fishing line 10 ends in a mushroom shape, plug, disc, etc. that locks with indentations in the enlarged shank 32 to prevent the fishing line 10 from being removed after assembly.

Referring to FIGS. 1-5, overall aspects of the hollow shank fishing hook 12 will be discussed. The hollow shank fishing hook 12 is made from any suitable material such as plastic, glass, metal, fiberglass, composite products, carbon fiber, fiber-reinforced polymers, glass-reinforced plastic, carbon-fiber reinforced plastic, etc. In one embodiment, the hollow shank fishing hook 12 is made of a material with an index of refraction very close to that of water to minimize visibility to fish. When combined with the fishing line 10 made of fluorocarbon, only the bait will be visible to the fish, with the fishing line 10 and hollow shank fishing hook 12 being nearly invisible in the water. In other embodiments, the hollow shank fishing hook 12 is colored (e.g., red, green, blue, yellow, etc.), while in other embodiments the hollow shank fishing hook 12 is colorless (i.e., clear). In some embodiments, the adhesive 40/42/44/46 is colored (e.g., red, green, blue, yellow, etc.), while in other embodiments the adhesive 40/42/44/46 is colorless (i.e., clear).

Referring now to FIGS. 6-8 of the drawings, a third embodiment of the hollow shank fishing hook 60 can be seen having a hollow shank 61 with an integrally extending hollow curve portion 62 terminating into an end point at 63 with an angularly disposed return barb 64 extending therefrom defining a fishing hook configuration. The shank 61 in this example is cross-sectionally round, but may be other shapes as a nature of design choice.

The shank 61 has a flared fusto conical end opening at 65 to provide ease of fishing line insertion as will be described in greater detail hereinafter.

It will be seen that the hollow shank 61 and the curved portion 62 therefore have a continuous annular wall 66 which defines an elongated tubular fishing line receiving passageway 67 therethrough.

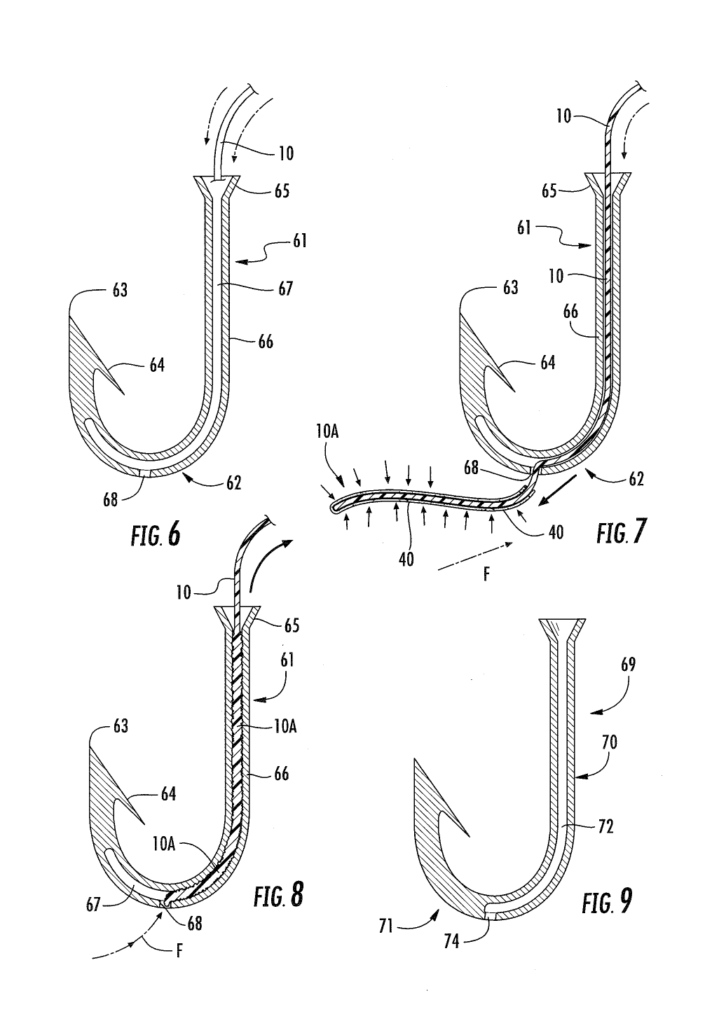

A line egress opening at 68 is provided within the annular wall 66 within the curved portion 62 midway therealong, best seen in FIG. 6 of the drawings. The fishing line 10, as hereinbefore described, and in this example of the alternate form in use is inserted through the flared end opening 65 into the tubular fish line receiving passageway 67 through the shank 61 and partially through the curved portion 62 before exiting through the line egress opening 68 as best seen in FIG. 7 of the drawings.

As noted, in operation, once a significant portion of the fishing line 10 extends from the hook by the egress opening 68 indicated as 10A the surface is coated with an adhesive 40 of a sufficient viscosity to adhere and be retained to the surface of the fishing line as will be evident and well known by those skilled in the art.

The adhesive 40 chosen in this application may be of any number available depending on chosen activation method and medium as hereinbefore described in the prior preferred form of the invention.

Once the adhesive 40 is applied, the line portion 10A is then drawn back into the fishing line receiving passageway 67 indicated by directional force arrows F seen in FIGS. 7 and 8 of the drawings.

Given the diameter of the fishing line 10 and the fixed determined interior dimension of the elongated line receiving passageways 67, the adhesive will be drawn into thereabout forming a cohesive bond of high frictional co-efficiency and which once set will permanently secure the line portion 10A securely within the hook 60 as illustrated graphically in FIG. 8 of the drawings.

It will be evident that the so embedded and adhesively affixed fishing line 10 positioned therewithin will assure a strong force appropriate bond having a co-lateral forced deployment under line induced force applicant to use requirements in fishing.

Referring now to FIG. 9 of the drawings, an alternate form of the hollow hook can be seen at 69 wherein a hollow shank 70 and a hollow hook integral curved portion 75 defines a secondary fishing line receiving interior passageway 72 that in this example terminates at a line exit and return opening 73 at or near the apex of the curved portion 71 as is positionally located in that of an egress opening 74 in the above described and disclosed third hook embodiment 60.

It will be evident therefore that the same fishing line insertion, pass through and exiting via an opening 74 will occur during use. Adhesive is applied as hereinbefore described and the line pulled back into the hook securing it therewithin. As noted, a variety of different waterproof adhesives may be used which include nature of adhesive activation as described and that application of adhesive may be prior to hook insertion wherein a post activation adhesive is used as will be known and evident to those skilled in the adhesive art.

It will therefore be seen that a new and novel alternate embodiment of the hollow shank fishing hook 60 has been illustrated and described and it will be evident to those skilled in the art that equivalent elements can be substituted for the one set forth above that which they perform in a substantially same manner in substantially the same way of achieving substantially the same result.

Additionally, in some embodiments the hollow shank fishing hook 12 is of a shape that minimizes drag through the water. This is illustrated in FIGS. 4 and 5, where the hollow shank fishing hook 12 has an elliptical shape that minimizes drag through the water. When combined with the absence of a knot, less turbulence is created as the hook is moved through the water, reducing or eliminating cavitation, and minimizing any noise created by the flow of water around the hook and line. This is yet another means by which the hook minimizes distractions to the fish, allowing the bait to be the main source of attention.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A hollow shank fishing hook comprising,
an elongated shank having a first end opening and a second closed end, the second closed end of the elongated shank of a curved portion,
a line egress opening in said curved shank portion in communication with a line receiving passageway within said hollow shank,
the second closed end of the elongated shank terminating in a point.

2. The hollow shank fishing hook set forth in claim 1 wherein said line receiving passageway extends between said first end opening and said opening in said curved shank portion.

3. The hollow shank fishing hook set forth in claim 1 wherein said shank is cross-sectionally round.

4. The hollow shank fishing hook set forth in claim 1 wherein said hollow shank and said hollow shank curve portion are integral and have a continuous annular wall defining said fishing line receiving passageway extending therethrough.

5. The hollow shank fishing hook set forth in claim 1 wherein said first end opening is of a fusto conical determination.

6. The hollow shank fishing hook set forth in claim 1 further comprises,
an adhesive, an adhesive being on a portion of a fishing line extending from said line egress opening in said curved shank portion of said hollow shank fishing hook.

7. The hollow shank fishing hook set forth in claim 6 wherein said adhesive is of a single part adhesive.

8. The hollow shank fishing hook set forth in claim 6 further comprises a portion of said fishing line having adhesive thereon retracted into said line receiving passageway and contained therewithin by said adhesive.

9. The hollow shank fishing hook set forth in claim 1 wherein said opening in said hollow shank curved portion is of a known diameter greater than that of said fishing line extending through said line receiving passageway within said hollow shank fishing hook.
